(19) United States
(12) Patent Application Publication
(10) Pub. No.: US 2008/0122830 A1
(43) Pub. Date: May 29, 2008

(54) Display device

(76) Inventors: Yoshihiro Kotani, Chiba (JP); Yoshinori Aoki, Mobara (JP); Taku Saito, Mobara (JP)

Correspondence Address: REED SMITH LLP, Suite 1400, 3110 Fairview Park Drive, Falls Church, VA, 22042, US

(21) Appl. No.: 11/976,040

(22) Filed: Oct. 19, 2007

(30) Foreign Application Priority Data
Oct. 19, 2006 (JP) 2006-284436

(51) Int. Cl. G06F 3/038

(52) U.S. Cl. 345/213

(57) ABSTRACT

To provide a display device capable of generating a power-on reset signal in the inside when the power is applied. A display panel and a drive circuit driving respective pixels in the display panel are included, and VCC voltage is inputted to the drive circuit, in which the drive circuit includes a power-on reset circuit generating a reset signal when the power is applied. The power-on reset circuit generates the reset signal by comparing the VCC voltage to diode voltage inside the power-on reset circuit. The drive circuit includes a VDD generation circuit generating VDD voltage lower than the VCC voltage from the VCC voltage, a control circuit generating a stop signal stopping operation of the VDD generation circuit by input of a stop set signal, inputting the stop signal to the VDD generation circuit and a control signal generation circuit inputting the stop set signal to the control circuit when the power is applied, in which the control signal generation circuit generates the stop set signal based on a first delay signal generated by delaying the reset signal and a second delay signal generated by delaying the first delay signal.

### CLAIM OF PRIORITY

The present application claims priority from Japanese application serial No. 2006-284436, filed on Oct. 19, 2006, the content of which is hereby incorporated by reference into this application.

### BACKGROUND OF THE INVENTION

1. Field of the Invention

The present invention relates to a display device, particularly, relates to an efficient technique when the power of a liquid crystal display device is turned on.

2. Description of the Related Art

A liquid crystal display module of a TFT (Thin Film Transistor) system having a small liquid crystal display panel is widely used as a display unit of a cellular phone, a digital camera and the like.

In a drive circuit (driver) used for the small liquid crystal display module, a power source circuit is included inside. The power source circuit generates internal logic voltage of VDD from VCC voltage inputted from the outside.

Generally, in the drive circuit used for the liquid crystal display module for a cellular phone or a digital camera, especially in the case such as including a power source circuit having a boosting circuit, it is necessary to input a power-on reset signal (hereinafter, simply referred to as a reset signal) for internal initialization when the power is applied.

### SUMMARY OF THE INVENTION

As described above, in the drive circuit used for the liquid crystal display module for a cellular phone or a digital camera, it is necessary to input a reset signal for internal initialization when the power is applied, however, there is a case when the reset signal is not inputted, and in such case, it is necessary to generate a reset signal in the inside when the power is applied.

The reset signal is necessary for both a block operating by VCC voltage as interface voltage and a block operating by VDD voltage as internal logic voltage.

The invention is made for solving the problems of related arts, and an object of the invention is to provide a display device capable of generating a power-on reset signal in the inside when the power is applied.

The above and other objects and novel characteristics of the invention will be clarified by description in the specification and the attached drawings.

The Summary of typical inventions among inventions disclosed in the application will be briefly explained as follows:

(1) A display device includes a display panel and a drive circuit driving respective pixels in the display panel and VCC voltage is inputted to the drive circuit, in which the drive circuit has a power-on reset circuit generating a reset signal when the power is applied, and the power-on reset circuit generates the reset signal by comparing the VCC voltage to diode voltage inside the power-on reset circuit.

(2) In the above (1), the drive circuit includes a VDD generation circuit generating VDD (VDD<VCC) voltage lower than the VCC voltage from the VCC voltage and a VDD reset signal generation circuit generating a VDD reset signal, in which the VDD reset signal generation circuit generates the VDD reset signal by delaying VDD voltage outputted from the VDD generation circuit after the VDD generation circuit is operated by input of the reset signal.

(3) In the above (1), the drive circuit includes a VDD generation circuit generating VDD (VDD<VCC) voltage lower than the VCC voltage from the VCC voltage, a control circuit generating a stop signal stopping operation of the VDD generation circuit by input of a stop set signal, inputting the stop signal to the VDD generation circuit and a control signal generation circuit inputting the stop set signal to the control circuit when the power is applied, in which the control signal generation circuit generates the stop set signal based on a first delay signal generated by delaying the reset signal and a second delay signal generated by delaying the first delay signal.

(4) In the above (3), the drive circuit includes a logic circuit to which the stop signal outputted from the control circuit and the second delay signal are inputted, which controls the passing of the stop signal, and the logic circuit prevents the passing of the stop signal outputted from the control circuit based on the second delay signal during a period from the power application until the control circuit outputs the stop signal based on the set signal, and outputs the signal stopping operation of the VDD generation circuit.

(5) In the above (3) or (4), the drive circuit includes a VDD reset signal generation circuit generating a VDD reset signal, and the VDD reset signal generation circuit delays VDD voltage outputted from the VDD generation circuit after the VDD generation circuit is operated by input of the reset signal to generate the VDD reset signal.

(6) In the above (5), any one of the stop set signal generated in the control signal generation circuit or the VDD reset signal generated in the VDD reset signal generation circuit can be selected when the power is applied by a switching signal inputted to the drive circuit.

(7) In any one of (1) to (6), the display device is a liquid crystal display device and the display panel is a liquid crystal display panel.

An advantage obtained by typical inventions among inventions disclosed in the application will be briefly explained as follows.

According to the invention, it is possible to provide a display device capable of generating a poser-on reset signal in the inside when the power is applied.

### BRIEF DESCRIPTION OF THE DRAWINGS

FIG. 1 is a block diagram showing a schematic configuration of a liquid crystal display module according to an embodiment of the invention;

FIG. 2 is a block diagram for explaining a circuit configuration relating to generation of a reset signal in a power source circuit shown in FIG. 1;

FIG. 3 is a diagram showing circuit configurations of a power-on reset signal generation circuit and a control signal generation circuit shown in FIG. 2;

FIG. 4 is a circuit diagram showing a circuit configuration of a voltage detection circuit shown in FIG. 3;

FIG. 5 is a diagram for explaining a generation method of a deep standby signal in the embodiment of the invention;

FIG. 6 is a view showing voltage waveforms of respective parts in FIG. 3;

FIG. 7 is a circuit diagram showing a circuit configuration of a VDD reset signal generation circuit shown in FIG. 2; and

FIG. 8 is a view showing voltage waveforms of respective parts in FIG. 7.

### DESCRIPTION OF THE PREFERRED EMBODIMENTS

Hereinafter, an embodiment of the invention will be explained in detail with reference to the drawings.

In all drawings for explaining the embodiment, the same signs are put to components having the same functions and repeated explanation thereof will be omitted.

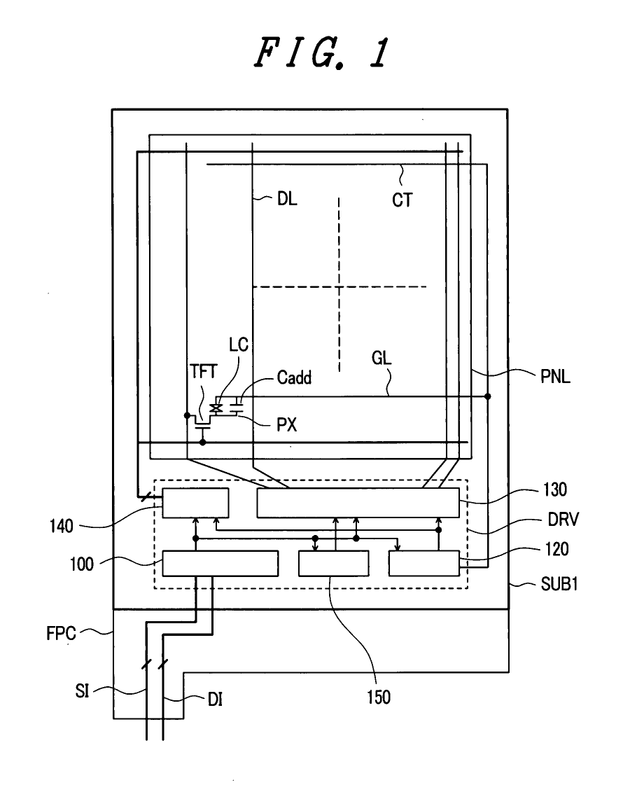

FIG. 1 is a block diagram showing a schematic configuration of a liquid crystal display module according to an embodiment of the invention. In the drawing, 100 denotes a controller circuit, 120 denotes a power source circuit, 130 denotes a source driver, 140 denotes a gate driver, 150 denotes a memory circuit, PNL denotes a liquid crystal display panel, DL denotes a video line (a source line or a drain lint), GL denote a scanning line (or a gate line), TFT denotes a thin-film transistor, PX denotes a pixel electrode, CT denotes a counter electrode (also referred to as a common electrode), LC denotes a liquid crystal capacitance, Cadd denotes a storage capacitance, SUB1 denotes a first glass substrate, DRV denotes a drive circuit and FPC denotes a flexible wiring board.

In the liquid crystal display panel (PNL), plural scanning lines (GL) and video lines (DL) are provided in parallel with each other. Sub-pixels are provided corresponding to portions in which the scanning lines (GL) and the video lines (DL) cross each other.

The plural sub-pixels are provided in a matrix state, and the pixel electrode (PX) and the thin-film transistor (TFT) are provided at each sub-pixel. In FIG. 1, the number of sub-pixels in the liquid crystal display panel (PNL) is 240×320×3.

The counter electrode (CT) is provided so as to be opposed to each pixel electrode (PX). Therefore, the liquid crystal capacitance (LC) and the storage capacitance (Cadd) are provided between each pixel electrode (PX) and each counter electrode (CT).

The liquid crystal display panel (PNL) is formed by processes in which the first glass substrate (SUB1) on which the pixel electrodes (PX), the thin-film transistors (TFT) and the like are provided is overlapped on a second glass substrate (not shown) on which a color filter and the like are formed with a prescribed gap, and both glass substrates are bonded to each other by a sealant provided in a frame shape in the vicinity of a peripheral edge portion between the both glass substrates as well as liquid crystal is filled inside the sealant between the both substrates from an opening for filling liquid crystal provided at a part of the sealant to seal the both substrates, and further, polarizing plates are attached to the outside of the both glass substrates.

Since the invention is not related to the internal configuration of the liquid crystal display panel, the detailed explanation of the internal configuration of the liquid crystal display panel is omitted. In addition, the invention can be applied to the liquid crystal display panel having any type of configuration. For example, in the case of a twisted nematic system, the counter electrode (CT) is formed on the second glass substrate. In the case of an in-plane switching system, the counter electrode (CT) is formed on the first glass substrate (SUB1).

In the liquid crystal display module shown in FIG. 1, the drive circuit (DRV) is mounted on the first glass substrate (SUB1).

The drive circuit (DRV) includes the controller circuit 100, the source driver 130 driving the video lines (DL) of the liquid crystal display panel (PNL), the gate driver 140 driving the scanning lines (GL) of the liquid crystal display panel (PNL), the power source circuit 120 generating power source voltage and the like necessary for displaying images on the liquid crystal display panel (PNL) and the memory circuit 150.

The case in which the drive circuit (DRV) is configured by a piece of semiconductor chip is shown in FIG. 1, however, it is also preferable that the drive circuit (DRV) is formed directly on the first glass substrate (SUB 1) by using, for example, thin-film transistors using low-temperature polysilicon in a semiconductor layer.

Similarly, it is preferable that some circuits of the drive circuit (DRV) are divided to form the drive circuit (DRV) by plural semiconductor chips, and some circuits of the drive circuit (DRV) are formed directly on the first glass substrate (SUB1) by using thin-film transistors using low-temperature polysilicon in the semiconductor layer.

In addition, it is preferable that the drive circuit (DRV) or some circuits of the drive circuit (DRV) are formed on a flexible wiring board, instead of mounting on the first glass substrate (SUB1).

In the controller circuit 100, display data and a display control signal are inputted from a micon (Micro controller unit; hereinafter, referred to as MCU) at the body side or from a graphic controller and the like.

In FIG. 1, SI denotes a system interface, which is a system to which various control signals and image data are inputted from the MCU and the like.

DI denotes a display data interface (RGB interface), which is a system (external data) to which image data formed at the external graphic controller and a clock for capturing data are continuously inputted.

In the display data interface (DI), image data is sequentially captured so as to correspond to the clock for capturing in the same way as a conventional drain driver used in a personal computer.

The controller circuit 100 transmits image data received from the system interface (SI) and the display data interface (DI) to the source driver 130 and the RAM 150 to control display.

In the liquid crystal display module of the embodiment, when the power is applied, a power-on reset signal (hereinafter, simply referred to as a reset signal) is formed in the inside with respect to both a block operating by VCC voltage as interface voltage, and a block operating by VDD voltage as internal logic voltage.

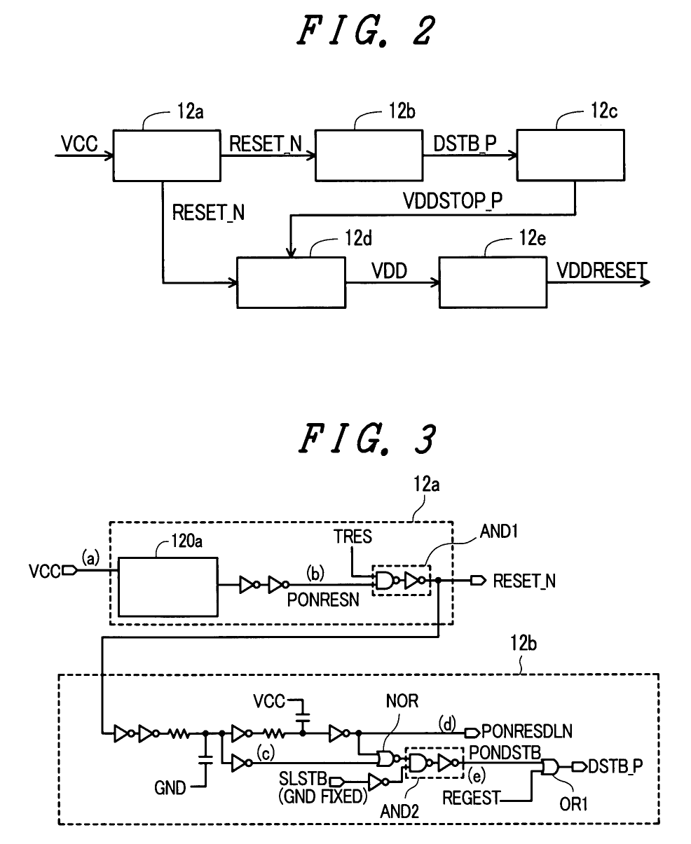

FIG. 2 is a block diagram for explaining a circuit configuration relating to generation of the reset signal in the power source circuit 120 shown in FIG. 1.

In FIG. 2, 12a denotes a power-on reset signal generation circuit, 12b denotes a control signal generating circuit generating a deep-standby set signal (stop set signal of the invention), 12c denotes a deep standby signal generation circuit generating a deep standby signal (stop signal of the invention), 12d denotes a VDD generation circuit and 12e denotes a VDD reset signal generation circuit.

The VDD generation circuit (12d) generates logic circuit power source voltage (VDD) from VCC voltage inputted from the outside by an internal regulator circuit.

FIG. 3 is a diagram showing a circuit configuration of the power-on reset signal generation circuit (12a) and the control signal generation circuit (12b) shown in FIG. 2.

In FIG. 3, 120a denotes a voltage detection circuit which outputs a high-level detection signal (PONRESN) when VCC voltage exceeds a certain value.

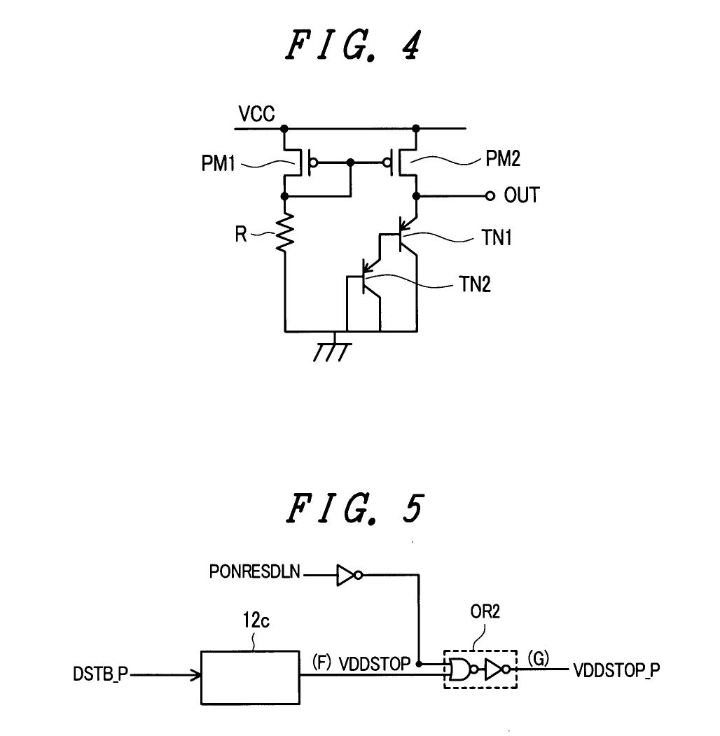

In FIG. 4, a circuit configuration of the voltage detection circuit (120a) shown in FIG. 3 is shown.

The voltage detection circuit (120a) shown in FIG. 4 includes a current mirror circuit having P-type MOS transistors of PM1 and PM2, a resistance R and a PNP transistor (TN1) to which a diode-connected PNP transistor (TN2) is connected between a base and a collector.

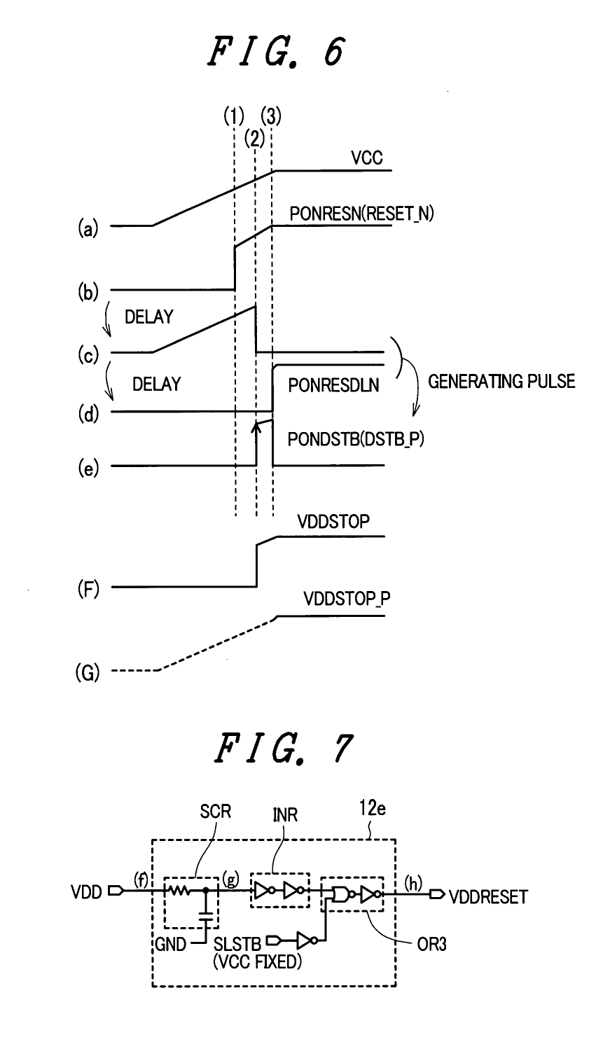

In the liquid crystal display module of the embodiment, VCC voltage rises when the power is applied as shown in FIG. 6A. In the voltage detection circuit (120a) shown in FIG. 4, the high-level detection signal (PONRESN) shown in FIG. 6B is outputted when the VCC voltage exceeds the internal diode voltage (voltage between base and emitter of the PNP transistor (TN1) and voltage between base and emitter of the PNP transistor (TN2)) (at a point of (1) in FIG. 6).

The detection signal (PONRESN) passing through the two inverter circuits and a signal (VCC-fixed signal in this case) inputted to a TRES terminal from the outside are inputted to an AND circuit (AND1), the output therefrom is used as a reset signal (RESET_N). It is also applied to a system in which the reset signal is inputted by inputting a reset signal from the outside to the TRES terminal.

A VDD reset signal is necessary for the block operating by VDD voltage as the internal logic voltage.

In the embodiment, the VDD reset signal is inputted to the block operating by VDD voltage according to the following two methods. First, a first method is explained.

In the liquid crystal display module of the embodiment, there is a “deep standby” mode in which operation of the VDD generation circuit (12d) is stopped as an operation mode. When returning from the “deep standby” mode (that is, when the VDD generation circuit (12d) is activated), the signal is inputted, therefore, the VDD reset signal is inputted to the block operating by VDD voltage according to an auto sequence function.

In the embodiment, as the first method, a deep-standby set signal (DSTB_P) is generated from the reset signal (RESET_N) in the control signal generation circuit (12b) when the power is applied, thereby setting the “deep standby” mode which stops operation of the VDD generation circuit (12d).

In FIG. 3, the reset signal (RESET_N) is delayed twice, and a signal delayed once shown in FIG. 6C and an inversion signal (PONRESDLN) of the signal delayed twice shown in FIG. 6D are inputted to a NOR circuit (NOR).

An output of the NOR circuit (NOR) and a signal (GND-fixed signal in this case) inputted to an SLSTB terminal from the outside are inputted to an AND circuit (AND2), and an output of the AND circuit (AND2) and a resist output inputted to a REGEST terminal are inputted to an OR circuit (OR1), then, an output of the OR circuit (OR1) is used as a deep-standby set signal (DSTB_P) shown in FIG. 6E.

The deep-standby set signal (DSTB_P) is inputted to the deep-standby signal generation circuit (12c), and the deep-standby signal generation circuit (12c) generates a signal (VDDSTOP) shown in FIG. 6F based on the deep-standby set signal (DSTB_P). Accordingly, the VDD generation circuit (12d) goes into the “deep standby” mode at a point of FIG. 6(2).

A signal (VDDSTOP) is in a low level when not in the “deep-standby” mode, therefore, the VDD generation circuit (12d) operates from the power application until the “deep-standby” mode.

Therefore, as shown in FIG. 5, the signal (VDDSTOP) generated in the deep-standby signal generation circuit (12c) and an inversion signal of a signal (PONRESDLN) are inputted to an OR circuit (OR2), and an output of the OR circuit (OR2) is used as a deep-standby signal (VDDSTOP_P) to be inputted to the VDD generation circuit (12d).

As shown in FIG. 6D, the signal (PONRESDLN) is in a low level from the power application until a point of FIG. 6(3), therefore, the inverting signal of the signal (PONRESDLN) is in a high level from the power application until the point of FIG. 6(3).

Accordingly, as shown in FIG. 6G, the deep-standby signal (VDDSTOP_P) is not in the low level from the power application until the “deep standby” mode, therefore, the VDD generation circuit (12d) does not operate.

After that, cancellation of the “deep standby” mode is performed by the auto sequence function, and the VDD reset signal is inputted to the block operating by VDD voltage.

Next, a second method will be explained.

There is a case that a client requires a mode in which VDD voltage rises immediately after the power is applied (hereinafter, referred to as a “resume standby” mode). In the “resume standby” mode, the VDD generation circuit (12d) does not go into the “deep standby” mode, therefore, it is necessary to generate a VDD reset signal (VDDRESET).

In this case, since VDD voltage is generated in the regulator circuit inside the VDD generation circuit (12d) and rises, the rising time is fixed.

Therefore, in the VDD reset signal generation circuit (12e), the reset signal (VDDRESET) is generated based on a signal in which the VDD rising voltage is delayed by a CR circuit.

FIG. 7 is a circuit diagram showing a circuit configuration of the VDD reset signal generation circuit (12e) shown in FIG. 2.

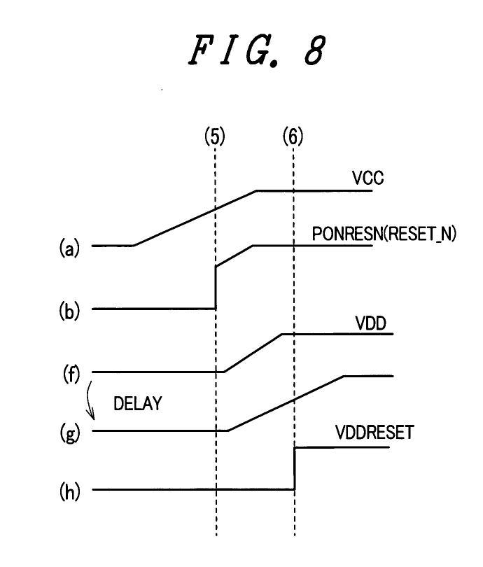

The VDD generation circuit (12d) operates from a point (point of FIG. 8(5)) when the reset signal (RESET_N) is inputted as shown in FIG. 8B. FIG. 8A schematically shows a rising state of VCC voltage.

Accordingly, as shown in FIG. 8F, VDD voltage rises, and the VDD voltage is delayed by the CR circuit (SCR) as shown in FIG. 8G. When the delayed VDD voltage exceeds a threshold voltage of an inverter circuit line (INR) (at a point of FIG. 8(6)), an output signal of the inverter circuit line (INR) goes into a high level.

The high-level output signal of the inverter circuit line (INR) and a signal (VCC-fixed signal in this case) inputted to an SLSTB terminal from the outside are inputted to an OR circuit (OR3), an output of the OR circuit (OR3) is used as a VDD reset signal (VDDRESET) shown in FIG. 8H.

In the embodiment, when the signal inputted to the SLSTB terminal from the outside is VCC voltage, the output of the AND circuit (AND2) goes into the low level, therefore, the deep standby set signal (DSTB_P) is not generated.

Therefore, in the embodiment, it is possible to switch between the “deep standby” mode (VDD generation circuit (12d) is stopped) and the “resume standby” mode (VDD generation circuit (12d) is activated) after the power application according to the signal to be inputted into the SLSTB terminal.

In the above explanation, the embodiment in which the invention is applied to the liquid crystal display module has been explained, however, it goes without saying that the invention is not limited to the above, and the invention can be applied to other display devices including the power source circuit.

The invention made by the present inventors has been specifically explained based on the embodiment, however, the invention is not limited to the embodiment and can be variously modified within a range not departing from the gist thereof.

What is claimed is:

1. A display device, comprising:
a display panel; and
a drive circuit driving respective pixels in the display panel, in which VCC voltage is inputted to the drive circuit, and
wherein the drive circuit includes a power-on reset circuit generating a reset signal when the power is applied, and
wherein the power-on reset circuit generates the reset signal by comparing the VCC voltage to diode voltage inside the power-on reset circuit.

2. The display device according to claim 1,
wherein the drive circuit includes
a VDD generation circuit generating VDD (VDD<VCC) voltage lower than the VCC voltage from the VCC voltage and
a VDD reset signal generation circuit generating a VDD reset signal, and
wherein the VDD reset signal generation circuit generates the VDD reset signal by delaying VDD voltage outputted from the VDD generation circuit after the VDD generation circuit is operated by input of the reset signal.

3. The display device according to claim 1,
wherein the drive circuit includes
a VDD generation circuit generating VDD (VDD<VCC) voltage lower than the VCC voltage from the VCC voltage,
a control circuit generating a stop signal stopping operation of the VDD generation circuit by input of a stop set signal, inputting the stop signal to the VDD generation circuit and
a control signal generation circuit inputting the stop set signal to the control circuit when the power is applied, and
wherein the control signal generation circuit generates the stop set signal based on a first delay signal generated by delaying the reset signal and a second delay signal generated by delaying the first delay signal.

4. The display device according to claim 3,
wherein the drive circuit includes
a logic circuit to which the stop signal outputted from the control circuit and the second delay signal are inputted, which controls the passing of the stop signal, and
wherein the logic circuit prevents the passing of the stop signal outputted from the control circuit based on the second delay signal during a period from the power application until the control circuit outputs the stop signal based on the set signal, and outputs the signal stopping operation of the VDD generation circuit.

5. The display device according to claim 3,
wherein the drive circuit includes,
a VDD reset signal generation circuit generating a VDD reset signal, and
wherein the VDD reset signal generation circuit delays VDD voltage outputted from the VDD generation circuit after the VDD generation circuit is operated by input of the reset signal to generate the VDD reset signal.

6. The display device according to claim 5,
wherein any one of the stop set signal generated in the control signal generation circuit or the VDD reset signal generated in the VDD reset signal generation circuit can be selected when the power is applied by a switching signal inputted to the drive circuit.

7. The display device according to claim 1,
wherein the display device is a liquid crystal display device and the display panel is a liquid crystal display panel.
